(19) United States
(12) Patent Application Publication
(10) Pub. No.: US 2014/0278584 A1
(43) Pub. Date: Sep. 18, 2014

(54) ENHANCED ELECTRONIC HEALTH RECORD SYSTEM

(71) Applicant: ADP, Inc., Roseland, NJ (US)

(72) Inventors: Stephen Dart, Eltopia, WA (US); Matthew Barron, West Jordan, UT (US); Jared Rich, Midvale, UT (US); Lisa Louvar, Lehi, UT (US); Jared Alviso, Herriman, UT (US)

(73) Assignee: ADP, Inc., Roseland, NJ (US)

(21) Appl. No.: 14/216,734

(22) Filed: Mar. 17, 2014

Related U.S. Application Data
(60) Provisional application No. 61/789,548, filed on Mar. 15, 2013.

(51) Int. Cl. G06Q 50/24; G06Q 10/10

(52) U.S. Cl. CPC G06Q 50/24; G06Q 10/10
USPC 705/4

(57) ABSTRACT

The subject matter of the invention relates to systems and methods for creating and managing enhanced electronic health records. The invention comprises a computing device with a display that access a plurality of electronic health records. The computer device display presents the user with a template selection screen allowing the healthcare provider to select templates and input patient data related to a medical visit, billing code, or other financial data for internal use or for the use of one or more insurance providers.

### BACKGROUND

This application claims priority to U.S. Provisional Application Ser. No. 61/789,548, entitled “Enhanced Electronic Health Record System,” that was filed on Mar. 15, 2013.

Enhanced electronic health record systems (“EHR”) systems are known in the art. However, these systems present difficulties for healthcare providers to efficiently input and capture financial and clinical data associated with their patients.

The subject matter of this application relates to an improved EHR system. The EHR system described herein allows healthcare providers to efficiently capture and manage clinical and financial data associated with a plurality of their patients. Particularly, the EHR system possesses a template functionality that allows health care providers to easily and flexibly capture clinical chart data for a plurality of their patients. This includes acquiring the clinical information necessary for patient care, as well as documenting all data necessary for the Medicare and Medicaid EHR Incentive Program requirements (i.e., payments from the Federal Government to eligible professionals, eligible hospitals and critical access hospitals (CAHs) as they adopt, implement, upgrade or demonstrate meaningful use of certified EHR technology, such as meaningful use requirements) and Evaluation and Management coding requirements (“E/M”) to facilitate proper medical insurance claim processing and prevent a healthcare provider audits.

The disclosed subject matter contemplates functionality as presented on the display of an electronic device connected to a digital storage medium on which used data is stored. Where identified below, virtual “buttons,” drop-down menus, icons and similar items are understood to be elements presented on the display of an electronic device and “selectable” or capable of being manipulated by user input to an electronic device. User input is understood to encompass a wide variety of circumstances. For instance, user input could be text entry via a keyboard or selection of a virtual object via a computer mouse.

The disclosed subject matter brings business value to healthcare providers. By bringing this functionally fully to a mobile device, the healthcare provider has a tool that affords enhanced flexibility to do what they need independent of the location or device they choose to use.

### BRIEF SUMMARY

Disclosed is a system for managing EHR systems, particularly the creation and management of clinic notes related to clinical and financial data. A user with a computing device is presented with a graphical user interface having a template selection screen on which the user can select a template from which to build a clinical note. The template can automatically populate with historical clinical data related to a patient. The computing device may include a personal computer, tablet, cellphone, or the like. It is understood that embodiments of the disclosed subject matter can be executed on either a desktop or mobile platforms.

The user selects a template to use from the template selection screen in order to create a clinic note. The clinic note is automatically pre-formatted according to the selected template in order to aid the user in collecting relevant information about the patient. Additionally, the user may be able to bookmark information about a patient directly into the clinical note.

The details of one or more embodiments of the invention are set forth in the accompanying drawings and descriptions below. The foregoing summary is not intended to summarize each potential embodiment or every aspect of the disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 is a diagram of an embodiment of the disclosed system in which an electronic user device is connected to a remote server and where both the server and the user device have a digital storage segment.

FIG. 2 is a diagram of an embodiment of the disclosed system in which an electronic device has a local digital storage medium.

FIG. 3 is a diagram of an embodiment of the disclosed system in which all encoded storage is accomplished entirely on a remote storage medium.

FIG. 4 illustrates an embodiment in which a computing device presents a graphical user interface from which a healthcare provider can review patient data.

FIG. 5 illustrates an embodiment in which a computing device presents a graphical user interface from which a healthcare provider can review and input clinical patient data.

FIGS. 5(a) and 5(b) illustrate embodiments in which a computing device presents a default template and a user preference override, respectively.

FIG. 6 illustrates an embodiment in which a computing device presents a graphical user interface whereby a provider can review the clinical visit history of a patient.

FIG. 7 illustrates an alternate embodiment in which a computing device presents a graphical user interface whereby a provider can review the clinical visit history of a patient.

FIG. 8 illustrates an embodiment in which a computing device presents a graphical user interface that allows for the visual validation of a patient's identity while the healthcare provider captures clinical data.

FIGS. 9(a) and 9(b) illustrate embodiments in which a computing device presents a graphical user interface for the signoff process of a medical visit.

FIG. 10 illustrates an embodiment in which a computing device displays an image related to a patient's clinical data.

### DETAILED DESCRIPTION

Embodiments of the disclosed subject matter include methods and systems related to EHR systems and methods that enhance the ability to create and capture clinical and financial data. The EHR systems contain one or more templates on a graphical user interface that allows a healthcare provider to easily create and manage clinic notes and billing charges. Where identified below, virtual “buttons,” drop-down menus, icons and similar items are understood to be elements on the display of a computing device and “selectable” or capable of manipulation by user input on the computing device. Additionally, user input is understood to encompass a variety of circumstances, such as text entry via a keyboard or selection of a virtual object via a computer mouse or other selection instrumentality.

FIG. 1 is a diagram of an embodiment in which a computing device is connected to a remote server. The computing device 101 has a processor 102, display 103 and a first digital storage segment 104. The computing device 101 is capable of receiving user input from a user, such as a healthcare provider. Optionally, the display 103 on the computing device 101 is an electronic touch screen and user input is the interaction of a user with the touch screen. A first digital storage segment has encoded on it a number of clinic note templates. A server 105 has a processor 106 and a second digital storage segment 107. For the purposes of this application, a digital storage segment is any digital storage area, and optionally two comingled portions of a single hard drive or other storage medium. Second digital storage segment 107 has encoded on it a number of health records, each record associated with a particular patient.

Processor 102 of the computing device 101 communicates with the processor 106 of the server 105 through a network 108. The processor 102 of the computing device 101 accesses the clinic note templates encoded on the first digital storage segment and EHRs encoded on the second digital storage segment. The computing device 101 presents on the display 103 a template selection screen containing representations of a portion of the clinical and financial note templates. The computing device 101 can present on the display 103 numerous aspects of the disclosed subject matter.

FIG. 2 is a diagram of an alternate embodiment in which the computing device 201 has a processor 202, display 203, and a digital storage medium 204, which is comprised of a first digital storage segment 205 and a second digital storage segment 206. The clinical and financial note templates are encoded on the storage segment 205 and EHRs are encoded on a storage segment 206.

FIG. 3 is a diagram of an alternate embodiment in which both clinical and financial note templates and health records are stored remotely from a computing device. The computing device 301 has a display 302. The server 303 had a digital storage medium 304, which is comprised of a first digital storage segment 305 and a second digital storage segment 306. The computing device 301 communicates with a server 303 through the network 307.

FIGS. 4-10 illustrate exemplary embodiments of the disclosure, and it is understood that their content does not limit the scope of the disclosed subject matter.

FIG. 4 illustrates an embodiment in which a computing device presents a graphical user interface from which a healthcare provider can review patient data. For purposes of this disclosure, a healthcare provider may be a physician, nurse, physician's assistant, or the like. A healthcare provider may view all items related to one or patients within a graphical user interface on a computing device. This is otherwise known as a “review bin” 401. From the review bin 401, the healthcare provider can view all items that await approval or signature. This ensures that all patient clinical and financial data is captured and updated in the EHR system. The healthcare provider may also use the review bin to quickly identify the state of billing or charge slips so that he knows whether charge slips should be created or whether appointments with previously captured charges require review before signing off.

The review bin 401 contains several functional elements. For example, the review bin 401 has a chart item type filter that allows for the selection of “All Items” or “All Items” 410. The “All Items” 410 selection provides a list of all unsigned chart items, including all appointments lacking a charge slip. The review bin 410 also has simplified iconography to, among other actions, create a new charge slip with an icon (using an icon such as “+”) or to save an item for signature (using an icon such as a “pencil”). The review bin 410 can also be sorted by clicking one or more column headers 430 and 440, such as patient name and healthcare provider.

The review bin 410 allows a healthcare provider to preliminary assess his patient schedule before arriving at a medical facility. Upon arrival at the medical facility, the healthcare provider can review which patients have arrived and which ones he needs to see.

For example, the healthcare provider can visit the room of Bob Jones. The healthcare provider captures the medical visit by selecting the particular type of visit template that corresponds with the reason Bob Jones is to be seen. The healthcare provider then completes the visit template by capturing all additional clinical data related to the medical visit within the template.

FIG. 5 illustrates an embodiment in which a computing device presents a graphical user interface from which a healthcare provider can review and input additional clinical data related to the medical visit. The graphical user interface 500 allows the healthcare provider to input clinical data related to a healthcare diagnosis or medical procedure. The graphical user interface 500 also allows a healthcare provider to select a patient and immediately create either a new note or update financial data related to medical billing or claims data related to an insurance provider (such as a new charge-slip). This ensures that the healthcare provider can efficiently input a patient's financial and additional clinical data related to the medical visit, and also minimizes the possibility of error regarding capture charges.

The healthcare provider can review his schedule 510 within the master schedule for the medical practice, and select the particular patient record 520 in a given time slot. This allows the healthcare provider to visualize a patient as he prepares to create a note or capture chares so that he can be certain he is doing the work on the right patient and minimize the possibility of error. Moreover, the healthcare provider can input notes on the patient record 520 and select a specific template associated with the particular type of visit.

FIGS. 5(a) and 5(b) illustrate embodiments in which a computing device presents graphical interfaces in the form of a default template and a user preference override, respectively. The goal of these graphical user interfaces is to ensure that the template selection process provides a similar end goal experience of the EHR as it relates to defaulting types and templates. The healthcare provider may have a default template into which data related to the patient's current medical visit will be input. If that is the case, then the provider can select a default template type associated with the appointment types within the medical practice 540. By way of example, the default template 540 may be a 1 week follow-up, 2 week follow-up, 3 month follow-up, 6 month follow-up, general appointment, hospital follow-up, new patient, re-schedule, referral, or state school.

If the medical visit type is associated with a particular template type (but not a specific template), then the user will be taken to the template navigation screen with the appropriate template type category pre-selected. If the visit type is directly associated with a particular note template, the user will go directly into that template. By way of example, the user selects a particular default template 540 by using a virtual button or drop-down menu 550. Alternatively, the provider may override the default template setting and set his own user preferences to focus on specific template types 560.

FIGS. 6 and 7 illustrate embodiments in which a computing device presents graphical user interfaces whereby a provider can review the clinical visit history of a patient. The clinical visit history 600 allows a provider to easily identify what chart items are remaining to be signed on a given office visit with respect to a particular patient to ensure that the documentation is closed out. The clinical visit history 600 allows the provider to have a compressed view of chart items to see what appointments have associated chart items and also quickly identify any open work, and to also expand and shrink the visit history view to suit his user needs. By way of example, the clinical visit history 600 may have several tabs, such as patient information, visit history, medical summary, clinical notes, and laboratory results 610. Moreover, clinical visit history 600 displays the visit history with expanding capability to show all related chart item types to the requisite appointment 620. The clinical visit history also shows previous prescriptions, lab orders, and lab results 630. It also shows via red alerts, how many and which items are not yet signed (indicating an incomplete documentation), as well as dates and provider details for each chart item as well as visual status of signoff state. The clinical visit history 600 allows the provider to quickly input additional clinical patient data related to the medical visit (such as adding a new chart item) so that he can quickly capture whatever clinical charting, orders, or documentation is required. This ensures that the healthcare provider can quickly capture charges for a given appointment so that he does not have to pick up the charge slip and identify the appointment separately.

An alternate clinical visit history of a patient is displayed in FIG. 7. The clinical visit history screen 700 may have several tabs, such as patient information, visit history, medical summary, clinical notes, and laboratory results. The clinical visit history screen 700 also allows for the input of additional clinical data related to a medical visit, such as a charge slip, note, lab, message, or prescription description 720. An alternate means to capture clinical data to add to the chart is with the popover ‘Add to Visit’ list of options 710. This will provide entry similar to the buttons represented in the graphic as the patient record 520 depicted in FIG. 5.

FIG. 8 illustrates an embodiment in which a computing device presents a graphical user interface that allows for the visual validation of a patient's identity while the healthcare provider captures clinical data. The clinical visit screen 800 includes information such as the patient's name, note date, appointment date, provider, department, and facility. Additionally, the clinical visit screen 800 includes a patient photo 810 for whom he is capturing clinical data to ensure that he does not make a mistake in his charting. The screen displays a thumbnail of the patient photo within the Note tabs header bar 810.

FIGS. 9(a) and 9(b) illustrate embodiments in which a computing device presents a graphical user interface for the signoff process of a medical visit. This allows the healthcare provider to capture clinical data efficiently and save it to the system via a clinical visit screen 900. When the healthcare provider chooses “done,” he will be presented with a save note option 910, whereby the health care provider may sign and save the note, save the note, or change the template. By selecting the “save and sign,” the healthcare provider can sign off without having to go through extra steps. The healthcare provider may select “save only” to save his current progress and revisit it at a later time. Also, if the healthcare provider arrives at the selected template and determines that this is not the template he wishes to use, the provider may quickly pick a different template. Optionally, the healthcare provider can automatically send a message 920 on the signing of a note to his front desk manager so that they know that he has completed a patient visit and to wait for the patient when they arrive at the front desk. For example, this can be set as a user preference 920 (e.g., “Popup Send Message” and “AutoSendMessge to”).

FIG. 10 illustrates an embodiment in which a computing device displays an image related to a patient's clinical data. The display 1000 of the computing device is able to present the results of previous or current X-Rays, MRIs, and the like. The display 1000 may also have a tool-bar 1010 in order to edit or provide notes for the patient's clinical records.

Other considerations relevant to the subject matter of this application concern “cloud” or remote storage of patient health care records. Particularly, this eliminates the need to store patient health care records on a particular computing device. Moreover, the EHR system's automatic downloading of templates identifies duplicate fields and resolves them without manual intervention. Furthermore, it is contemplated that the EHR system may support additional user preferences to ensure a consistent user experience when capturing clinical history data in the EHR system. For example, the healthcare provider will be able to capture clinical notes on either a desktop, mobile, or tablet computing device and be able to perform the same essential functions across all devices.

1. A system for managing electronic healthcare records associated with a plurality of patients, comprising:
a computing device, wherein the computing device is configured to:
receive historical clinical data associated with at least one patient;
display the historical clinical data associated with the at least one patient on a graphical user interface;
capture additional clinical data related to a medical visit associated with the at least one patient;
transmit the additional clinical data related to the medical visit to at least one digital storage segment; and
the least one digital storage segment, wherein the at least one digital storage segment is configured to store the received historical clinical data and the additional clinical data.

2. The system of claim 1, wherein the additional clinical data related to a medical visit comprises data related to at least one of a healthcare diagnosis or a medical procedure.

3. The system of claim 1, wherein the additional clinical data related to the medical visit comprises payment data related to at least one of a medical billing code, Medicare inventive program requirement, or Medicaid EHR incentive program requirement.

4. The system of claim 1, wherein the historical clinical data comprises patient data obtained from at least one insurance provider.

5. A method for managing electronic healthcare records associated with a plurality of patients, comprising:
receiving, by at least one computing device, historical clinical data associated with at least one patient, wherein the at least one computing device has a user interface configured to:
input clinical data related to a medical visit associated with at least one patient;
display the historical clinical data associated with the at least one patient;
capture clinical data related to a medical visit associated with the at least one patient;
transmit the additional clinical data related to the medical visit to at least one digital storage segment; and
storing, by the least one digital storage segment, the received historical clinical data and the additional clinical data related to the medical visit.

6. The method of claim 5, wherein the additional clinical data related to a medical visit comprises data related to at least one of a healthcare diagnosis or a medical procedure.

7. The method of claim 5, wherein the additional clinical data related to a medical visit comprises payment data related to at least one of a medical billing code, Medicare inventive program requirement, or Medicaid EHR incentive program requirement.

8. The method of claim 5, wherein the historical clinical data comprises patient clinical data obtained from at least one insurance provider.

9. An electronic health record system, comprising:
a computing device with a graphic user interface that is capable of receiving user input;
a first digital storage segment, wherein the at least one digital storage segment stores a plurality of templates to facilitate the input of clinical data related to a medical visit associated with at least one patient;
a second digital storage segment, wherein the second digital storage segment stores plurality of electronic healthcare records associated with the at least one patient; and
wherein the computing device is further capable of:
accessing the plurality of electronic healthcare records;
displaying at least one template to facilitate the input of clinical data;
input additional clinical data related to a medical visit within the at least one template; and
updating the clinical data related to at least one patient.

10. The system of claim 9, wherein the additional clinical data related to a medical visit comprises data related to at least one of a healthcare diagnosis or a medical procedure.

11. The system of claim 9, wherein the additional clinical data related to a medical visit comprises data related to at least one of an appointment scheduling, a clinic note, a medical summary, a prescription and a laboratory result.

12. The system of claim 9, wherein the additional clinical data related to a medical visit comprises data related to at least one of a medical billing code, Medicare incentive program requirements, and Medicaid EHR incentive program requirements.

13. The system of claim 9, wherein the additional clinical data related to a medical visit comprises claims data related to at least one insurance provider.
